(19) United States
(12) Patent Application Publication
(10) Pub. No.: US 2024/0430570 A1
(43) Pub. Date: Dec. 26, 2024

(54) ELECTRONIC DEVICE

(71) Applicant: GUANGDONG OPPO MOBILE TELECOMMUNICATIONS CORP., LTD., Dongguan (CN)

(72) Inventor: Hongsong LI, Dongguan (CN)

(73) Assignee: GUANGDONG OPPO MOBILE TELECOMMUNICATIONS CORP., LTD., Dongguan (CN)

(21) Appl. No.: 18/824,032

(22) Filed: Sep. 4, 2024

Related U.S. Application Data
(63) Continuation of application No. PCT/CN2022/142047, filed on Dec. 26, 2022.

(30) Foreign Application Priority Data
Mar. 11, 2022 (CN) 202210242291.X

(51) Int. Cl. H04N 23/68

(52) U.S. Cl. CPC H04N 23/687; H04N 23/681

(57) ABSTRACT

An electronic device is disclosed. The electronic device includes a camera module; an anti-shake motor assembly, arranged on the camera module; a main board; and a control module, arranged on the main board and electrically coupled to the anti-shake motor assembly, the control module being configured to determine a driving electrical signal based on a motion state of the electronic device and transmit the driving electrical signal to the anti-shake motor assembly, and the driving electrical signal being configured to drive the anti-shake motor assembly to achieve optical anti-shake.

### CROSS REFERENCE TO RELATED APPLICATIONS

The present disclosure is a continuation-application of International (PCT) Patent Application No. PCT/CN2022/142047 filed on Dec. 26, 2022, which claims priority to Chinese patent application No. 202210242291.X filed on Mar. 11, 2022, entitled “ELECTRONIC DEVICE”, the entire contents of which are incorporated herein by reference.

### TECHNICAL FIELD

The present disclosure relates to the field of electronic devices, and in particular to an imaging technology of an electronic device.

### BACKGROUND

With development and advancement of technologies, people have higher requirements for an imaging quality of electronic devices such as mobile phones. Shake is one of factors affecting imaging quality when the electronic devices are imaging. In order to improve imaging quality, optical anti-shake is required in the electronic devices.

It should be noted that information disclosed above is merely for convenience of understanding the background of the present disclosure, and therefore may include information that does not constitute information related art known to those of ordinary skill in the art.

### SUMMARY

In one aspect, the present disclosure provides an electronic device, the electronic device includes a camera module, an anti-shake motor assembly, a main board, and a control module. The anti-shake motor assembly is arranged on the camera module. The control module is arranged on the main board and electrically coupled to the anti-shake motor assembly. The control module is configured to determine a driving electrical signal based on a motion state of the electronic device, and transmit the driving electrical signal to the anti-shake motor assembly, and the driving electrical signal is configured to drive the anti-shake motor assembly to achieve optical anti-shake.

In another aspect, the present disclosure provides an electronic device, which includes a camera module; an anti-shake motor assembly, arranged on the camera module; and a control module, electrically coupled to the anti-shake motor assembly and non-integrated into the camera module, the control module being configured to determine a driving electrical signal based on a motion state of the electronic device and transmit the driving electrical signal to the anti-shake motor assembly, and the driving electrical signal being configured to drive the anti-shake motor assembly to achieve optical anti-shake.

In yet another aspect, the present disclosure provides an electronic device, which includes a camera module; an anti-shake motor assembly, arranged on the camera module; a circuit board, independent from the camera module; and a control module, arranged on the circuit board and electrically coupled to the anti-shake motor assembly, the control module being configured to determine a driving electrical signal based on a motion state of the electronic device and transmit the driving electrical signal to the anti-shake motor assembly, and the driving electrical signal being configured to drive the anti-shake motor assembly to achieve optical anti-shake.

It should be understood that the general description above and the detailed description as follows are merely exemplary and explanatory, and do not limit the present disclosure.

### BRIEF DESCRIPTION OF THE DRAWINGS

The drawings as follows are incorporated into and form part of the description, demonstrating embodiments of the present disclosure and illustrating principles of the present disclosure in conjunction with the description. Obviously, the drawings in the following description are merely some embodiments of the present disclosure, and those skilled in the art may obtain other drawings based on these drawings without creative work.

FIG. 1 is a structural block view of an electronic device according to some embodiments of the present disclosure.

FIG. 2 is a structural block view of an electronic device according to some embodiments of the present disclosure.

FIG. 3 is a schematic structure diagram of an electronic device according to some embodiments of the present disclosure.

FIG. 4 is a structural block view of an electronic device according to some embodiments of the present disclosure.

FIG. 5 is a structural block view of an electronic device according to some embodiments of the present disclosure.

FIG. 6 is a schematic structure diagram of a camera module according to some embodiments of the present disclosure.

FIG. 7 is a schematic structure diagram of a camera module according to some embodiments of the present disclosure.

FIG. 8 is a schematic structure diagram of a camera module according to some embodiments of the present disclosure.

### DETAILED DESCRIPTION

Implementations are described more fully with reference to the accompanying drawings. The implementations may be embodied in various forms and should not be construed as limited to the implementations described herein. In addition, the implementations are provided so that the present disclosure is exhaustive and complete, and enable ideas of the implementations to be fully communicated to those skilled in the art. The same reference numerals in the drawings indicate the same or similar structures, and thus detailed descriptions thereof are omitted.

Although relative terms, such as “top” and “bottom” are used in the specification to describe a relative relationship of one assembly to another assembly shown in the drawings, these terms such as the direction shown in the drawings are used in the specification merely for convenience. It can be understood that if the device shown in the drawings were turned upside down, assemblies described as “on top” would become described as “on bottom”. When a structure is “on” another structure, it may mean that the structure is integrally formed on the another structure, or that the structure is “directly” arranged on the another structure, or that the structure is “indirectly” arranged on the another structure through other structures.

An electronic device, comprising: a camera module; an anti-shake motor assembly, arranged on the camera module; a main board; and a control module, arranged on the main board and electrically coupled to the anti-shake motor assembly, the control module being configured to determine a driving electrical signal based on a motion state of the electronic device and transmit the driving electrical signal to the anti-shake motor assembly, and the driving electrical signal being configured to drive the anti-shake motor assembly to achieve optical anti-shake.

In some embodiments, the electronic device further comprises: a detecting module, arranged on the camera module and configured to detect a position of the camera module, wherein the detecting module is electrically coupled to the control module to feedback the position of the camera module to the control module.

In some embodiments, the detecting module comprises: a Hall sensor, arranged on the camera module and configured to collect the position of the camera module; and an amplification circuit, electrically coupled to the Hall sensor and the control module, and configured to amplify and transmit a signal collected by the Hall sensor to the control module.

In some embodiments, the control module comprises: an anti-shake determining unit, configured to determine a target angular displacement of an anti-shake motor of the anti-shake motor assembly based on the motion state of the electronic device; and a servo control unit, electrically coupled to the anti-shake determining unit, the detecting module, and the anti-shake motor assembly, and configured to control the anti-shake motor based on the target angular displacement and the position of camera module.

In some embodiments, the amplification circuit comprises: an amplifier, comprising an input terminal, an output terminal, and a control terminal, the input terminal being electrically coupled to the Hall sensor; an analog-to-digital conversion unit, electrically coupled to the output terminal and the servo control unit; and a digital-to-analog conversion unit, electrically coupled to the control terminal.

In some embodiments, the anti-shake motor assembly comprises: a first driver, connected to the camera module and configured to drive the camera module to rotate around a first direction; and a second driver, connected to the camera module and configured to drive the camera module to rotate around a second direction, wherein the first direction is perpendicular to the second direction.

In some embodiments, the anti-shake motor assembly further comprises: a first driving chip is electrically coupled to the control module and the first driver, and configured to transmit the driving electrical signal to the first driver; and a second driving chip electrically coupled to the control module and the second driver, and configured to transmit the driving electrical signal to the second driver.

In some embodiments, the detecting module comprises: a first detecting unit, arranged on the camera module and configured to detect an actual angle of the camera module around the first direction; and a second detecting unit, arranged on the camera module and configured to detect an actual angle of the camera module around the second direction.

In some embodiments, the control module is electrically coupled to the first detecting unit and the second detecting unit; the control module is configured to obtain the actual angle of the camera module around the first direction from the first detecting unit, and compensate a rotation angle of the camera module around the second direction determined by the control module based on the actual angle of the camera module around the first direction; or the control module is configured to obtain the actual angle of the camera module around the second direction from the second detecting unit, and compensate a rotation angle of the camera module around the first direction determined by the control module based on the actual angle of the camera module around the second direction.

In some embodiments, the camera module comprises: a lens, configured to collect ambient lights; and a sensor, configured to receive the lights transmitted by the lens and convert an optical signal into an electrical signal.

In some embodiments, the anti-shake motor assembly comprises: a first motor, arranged on the sensor and configured to drive the sensor to achieve optical anti-shake of the sensor.

In some embodiments, the first motor is a shape memory alloy motor, and the first motor comprises: a first motor body; and a first driving unit, connected to the first motor body and a rear surface of the sensor.

In some embodiments, the anti-shake motor assembly comprises: a second motor, arranged on the lens and configured to drive the lens to achieve optical anti-shake of the lens.

In some embodiments, the second motor comprises: a second motor body; and a second driving unit, connected to the second motor body and the lens.

In some embodiments, a through hole is defined on the second motor body, and the lens is disposed in the through hole.

In some embodiments, the electronic device further comprises: a motion sensor module, electrically coupled to the control module and configured to detect the motion state of the electronic device and transmit the motion state of the electronic device to the control module.

In some embodiments, the motion sensor module comprises a gyroscope sensor or a six-axis acceleration sensor.

An electronic device is provided, comprising: a camera module; an anti-shake motor assembly, arranged on the camera module; and a control module, electrically coupled to the anti-shake motor assembly and non-integrated into the camera module, the control module being configured to determine a driving electrical signal based on a motion state of the electronic device and transmit the driving electrical signal to the anti-shake motor assembly, and the driving electrical signal being configured to drive the anti-shake motor assembly to achieve optical anti-shake.

In some embodiments, the electronic device further comprises: a circuit board, independent from the camera module; wherein the control module is arranged on the circuit board.

An electronic device is provided, comprising: a camera module; an anti-shake motor assembly, arranged on the camera module; a circuit board, independent from the camera module; and a control module, arranged on the circuit board and electrically coupled to the anti-shake motor assembly, the control module being configured to determine a driving electrical signal based on a motion state of the electronic device and transmit the driving electrical signal to the anti-shake motor assembly, and the driving electrical signal being configured to drive the anti-shake motor assembly to achieve optical anti-shake.

The embodiments of the present disclosure provide an electronic device. As shown in FIG. 1, the electronic device 1 includes a camera module 110, an anti-shake motor assembly 120, a main board 130, and a control module 140. The anti-shake motor assembly 120 is arranged on the camera module 110. The control module 140 is arranged on the main board 130, and the control module 140 is electrically coupled to the anti-shake motor assembly 120. The control module 140 is configured to determine a driving electrical signal based on a motion state of the electronic device 1, and transmit the driving electrical signal to the anti-shake motor assembly 120. The driving electrical signal is configured to drive the anti-shake motor assembly 120 to achieve optical anti-shake. The main board is a circuit board, which is independent from the camera module. That is, the main board is spaced from the camera module without any relation.

In the electronic device 1 provided in the embodiments of the present disclosure, as the anti-shake motor assembly 120 is arranged on the camera module 110 to drive the camera module 110 and the control module 140 is arranged on the main board 130 to output the driving electrical signal which drive the anti-shake motor assembly 120, optical anti-shake of the electronic device 1 is achieved. That is, the control module is non-integrated into the camera module.

In related arts, a control module with optical anti-shake is integrated into a camera module. Control parameters in the control module are preset and cannot be adjusted by an electronic device, resulting in low anti-shake accuracy in some application scenarios (e.g., motor resonance or magnetic interference). In the embodiments of the present disclosure, the control module 140 is arranged on the main board 130, avoiding the problem of low optical anti-shake control accuracy caused by the integration of the control module 140 into the camera module 110, such that the electronic device 1 is enabled to control optical anti-shake based on the state of the electronic device 1, thereby improving the optical anti-shake accuracy of the electronic device 1. In addition, the control module 140 is arranged separately from the camera module 110, which may reduce the cost of the camera module 110, thereby saving the cost of the electronic device 1.

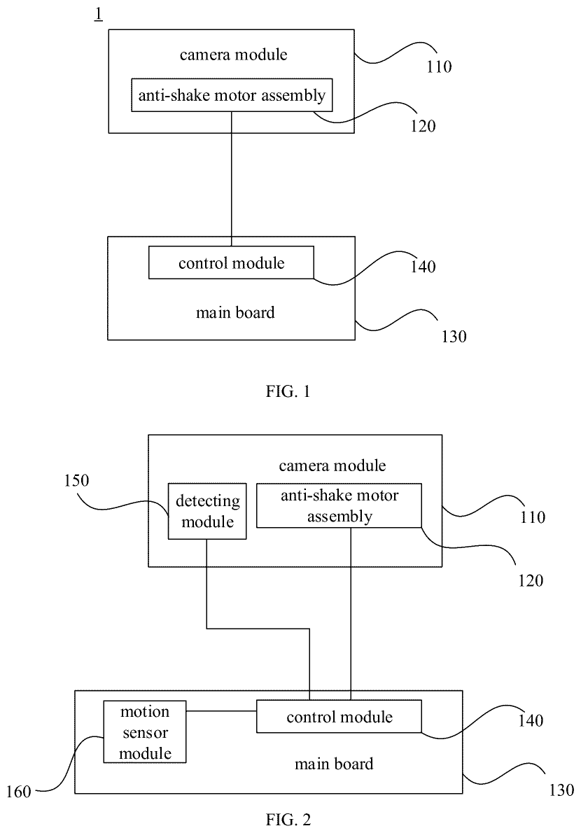

As shown in FIG. 2, the electronic device provided by the embodiments of the present disclosure may also include a detecting module 150 and a motion sensor module 160. The detecting module 150 is arranged on the camera module 110. The detecting module 150 is configured to detect a position of the camera module 110. The detecting module 150 is electrically coupled to the control module 140 to feedback the position of the camera module 110 to the control module 140. The motion sensor module 160 is connected to the control module 140. The motion sensor module 160 is configured to detect the motion state of the electronic device 1 and transmit motion state information of the electronic device 1 to the control module 140. That is, the motion sensor module 160 is configured to detect the motion state of the electronic device 1 and transmit the motion state of the electronic device 1 to the control module 140.

Each part of the electronic device 1 provided by the embodiments of the present disclosure is described in detail as follows.

The electronic device 1 provided by the embodiments of the present disclosure may be a mobile phone, a tablet computer, an electronic reader, a smart watch, smart glasses, a camera, a camcorder, etc. The electronic device is described in detail below by taking the electronic device 1 as a mobile phone.

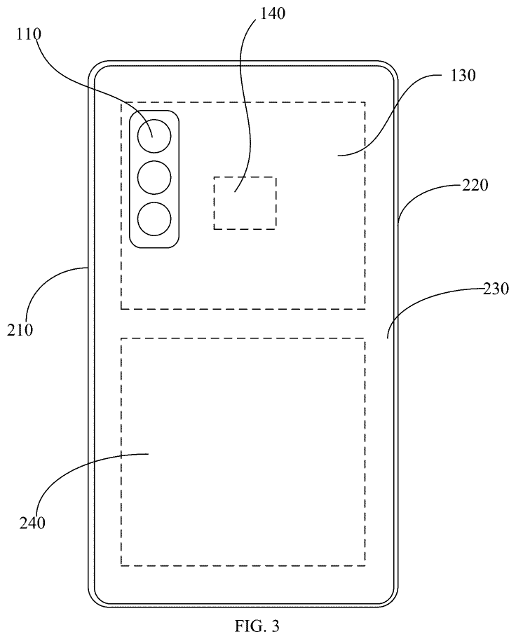

As shown in FIG. 3, the electronic device 1 may also include a display screen 210, a frame 220, a rear cover 230, and a battery 240. The display screen 210 and the rear cover 230 are respectively disposed at both sides of the frame 220 and connected to the frame 220. The display screen 210, the frame 220, and the rear cover 230 form a main structure of the electronic device 1. The main structure is defined with an accommodation cavity, and the main board 130 and the battery 240 are disposed in the accommodation cavity.

The camera module 110 may be a front camera or a rear camera of the electronic device 1. When the camera module 110 is a front camera, the display screen 210 may be defined with a hole, and the camera module 110 is disposed in the hole of the display screen 210. Alternatively, the electronic device 1 may be an under-screen camera electronic device 1, and the camera module 110 is disposed on the back of the display screen 210. When the camera module 110 is a rear camera, the rear cover 230 is defined with a lens hole, and the camera module 110 may be mounted in the lens hole. The lens hole may be covered with a lens decorative plate.

The camera module 110 is configured to collect images, such as taking photos or videos. As shown in FIG. 6, the camera module 110 may include a lens 112 and a sensor 111. The lens 112 is configured to collect ambient light. The sensor 111 is configured to receive the light transmitted by the lens 112 and converts an optical signal into an electrical signal.

In the embodiments of the present disclosure, the camera module 110 may be a linear camera module or a periscope camera module. When the camera module 110 is a linear camera module, the sensor 111 is located at a light output side of the lens 112, and an optical axis of the lens 112 is perpendicular to a light-sensitive surface of the sensor 111. When the camera module 110 is a periscope camera module, a reflector may be arranged between the sensor 111 and the lens 112, and a direction of the light transmitted by the lens 112 is changed by the reflector. For example, the reflector may be located at an angle of 45 degrees from the optical axis of the lens 112 to deflect the light transmitted by the lens 112 by 90 degrees, and the sensor 111 is located on a transmission path of the deflected light.

The lens 112 may include one or more optical lenses. When the lens 112 includes multiple optical lenses, the multiple optical lenses are sequentially arranged along the optical axis of the lens 112. Each of the optical lenses is a transparent lens, and materials of the optical lenses may be transparent materials such as glass or plastic. The multiple optical lenses may use a same material, or the multiple optical lenses may use different materials. For example, some of the multiple optical lenses are plastic lenses and some are glass lenses. The multiple optical lenses may include concave lenses, convex lenses, spherical lenses, aspheric lenses, etc.

The lens 112 may also include a lens barrel. The lens barrel is defined with a mounting hole, and one or more optical lenses are disposed in the mounting hole. For example, the lens barrel may be a cylindrical lens barrel, the lens barrel is defined with a cylindrical mounting hole, and the optical lenses are circular lenses. The optical lenses are mounted in the mounting hole, and the optical lenses may be fixedly connected to the lens barrel. Alternatively, the optical lenses may be movably connected to the lens barrel.

The sensor 111 is an image sensor, and the image sensor may be a charge coupled device (CCD) sensor or a complementary metal oxide semiconductor (CMOS) sensor. The sensor 111 includes photodiodes distributed in an array, an output circuit, and a substrate. The photodiodes are connected to the output circuit, and the photodiodes and the output circuit are packaged in the substrate. The photodiodes are configured to convert optical signals into electrical signals, and the output circuit is configured to output the electrical signals.

The anti-shake motor assembly 120 is arranged on the camera module 110. The anti-shake motor assembly 120 is configured to drive the camera module 110 to rotate to achieve optical anti-shake. The anti-shake motor assembly 120 may be connected to the lens 112, and the anti-shake motor assembly 120 is configured for driving the lens 112 to rotate to achieve optical anti-shake. Alternatively, the anti-shake motor assembly 120 may be connected to the sensor 111, and the anti-shake motor assembly 120 is configured for driving the sensor 111 to rotate to achieve optical anti-shake. Alternatively, the anti-shake motor assembly 120 may be connected to both the lens 112 and the sensor 111 simultaneously, and the anti-shake motor assembly 120 is configured for driving the lens 112 and the sensor 111 to achieve optical anti-shake.

The control module 140 is arranged on the main board 130 and is electrically coupled to the anti-shake motor assembly 120. The control module 140 is configured to determine the driving electrical signal based on the motion state of the electronic device 1 and transmit the driving electrical signal to the anti-shake motor assembly 120. The driving electrical signal is configured to drive the anti-shake motor assembly 120 to achieve optical anti-shake.

The control module 140 is connected to the main board 130, and the control module 140 may be shared with a control component of the electronic device 1. For example, the control module 140 may be a central processor or a microprocessor of the electronic device 1.

The control module 140 is connected to the motion sensor module 160, and the control module 140 receives the motion state information of the electronic device 1 (e.g., acceleration and/or speed information of the electronic device 1) collected by the motion sensor module 160. The control module 140 determines position information of the electronic device 1 based on the acceleration of the electronic device 1, and determines a rotation angle of the lens 112 required for optical anti-shake based on the position information of the electronic device 1. The rotation angle of the lens 112 required for optical anti-shake may be decomposed into a rotation angle around a first direction and a rotation angle around a second direction. The first direction and the second direction are perpendicular to each other, and both the first direction and the second direction are perpendicular to the optical axis of the lens 112.

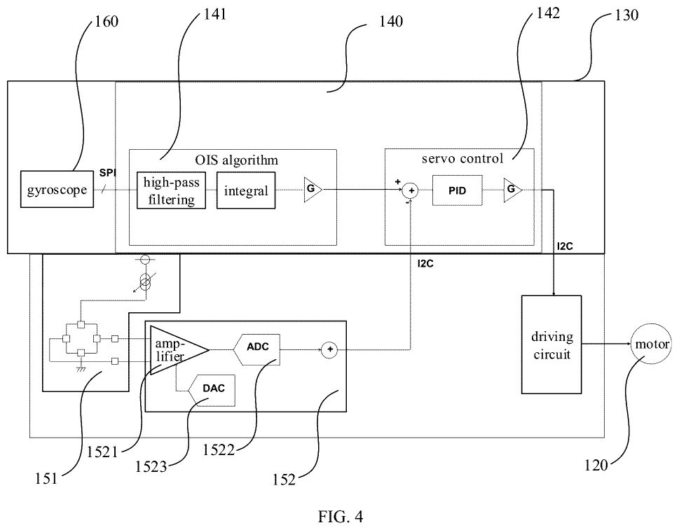

As shown in FIG. 4, the control module 140 may include an anti-shake determining unit 141 and a servo control unit 142. The anti-shake determining unit 141 is configured to determine a target angular displacement of an anti-shake motor of the anti-shake motor assembly 120 based on the motion state of the electronic device 1. The servo control unit 142 is electrically coupled to the anti-shake determining unit 141, the detecting module 150, and the anti-shake motor assembly 120. The servo control unit 142 is configured to control the anti-shake motor based on the target angular displacement and the position of the camera module 110.

The anti-shake determining unit 141 may obtain the acceleration information of the electronic device 1 from the motion sensor module 160 and integrate the acceleration of the electronic device 1 to determine a position change of the electronic device 1. During the optical anti-shake process, the motion of the camera module 110 is opposite to the motion of the electronic device 1, thereby counteracting the shaking of the electronic device 1. Therefore, the control module 140 may determine a target position of the camera module 110 in a manner of backward calculation based on the position of the electronic device 1. The driving electrical signal provided to the anti-shake motor assembly 120 is determined according to the target position of the camera module 110 and parameters of the anti-shake motor assembly 120.

In some embodiments, the anti-shake determining unit 141 may call an optical anti-shake algorithm to calculate an optical anti-shake position. The anti-shake determining unit 141 may perform high-pass filtering and integration on an acceleration signal of the electronic device 1, obtain the position of the electronic device 1, and convert the position into the driving signal of the anti-shake motor assembly 120.

The servo control unit 142 is configured to perform closed-loop feedback control on the anti-shake motor assembly 120. The servo control unit 142 may be a proportional integral differential (PID) control unit. The servo control unit 142 may be connected to the detecting module 150. The detecting module 150 is configured to detect an actual position of the camera module 110 in real time during the anti-shake process and transmit the actual position of the camera module 110 to the servo control unit 142. The servo control unit 142 performs closed-loop feedback control on the anti-shake motor assembly 120 based on the target position of the camera module 110 and the actual position of the camera module 110.

In the embodiments of the present disclosure, the control module 140 is also configured to detect whether the anti-shake motor assembly 120 resonates. When the anti-shake motor assembly 120 resonates, the control module 140 provides a resonance compensation signal to the anti-shake motor.

The control module 140 may detect a vibration frequency of the anti-shake motor assembly 120 and determine whether the vibration frequency of the anti-shake motor assembly 120 is close to a natural frequency of the anti-shake motor assembly 120. When the vibration frequency of the anti-shake motor assembly 120 is close to the natural frequency of the anti-shake motor assembly 120, the resonance compensation signal is provided to the anti-shake motor assembly 120 to prevent the anti-shake motor assembly 120 from resonating.

In some embodiments, the control module 140 may also include a resonance compensation unit, which detects the vibration frequency of the anti-shake motor assembly 120 and determines whether the vibration frequency of the anti-shake motor assembly 120 is close to the natural frequency of the anti-shake motor assembly 120. When the vibration frequency of the anti-shake motor assembly 120 is close to the natural frequency of the anti-shake motor assembly 120, the resonance compensation signal is provided to the anti-shake motor assembly 120 to prevent the anti-shake motor assembly 120 from resonating.

The motion sensor module 160 is electrically coupled to the control module 140. The motion sensor module 160 is configured to detect the motion state of the electronic device 1 and transmit the motion state information of the electronic device 1 to the control module 140. The motion sensor module 160 may include a gyroscope sensor or a six-axis acceleration sensor.

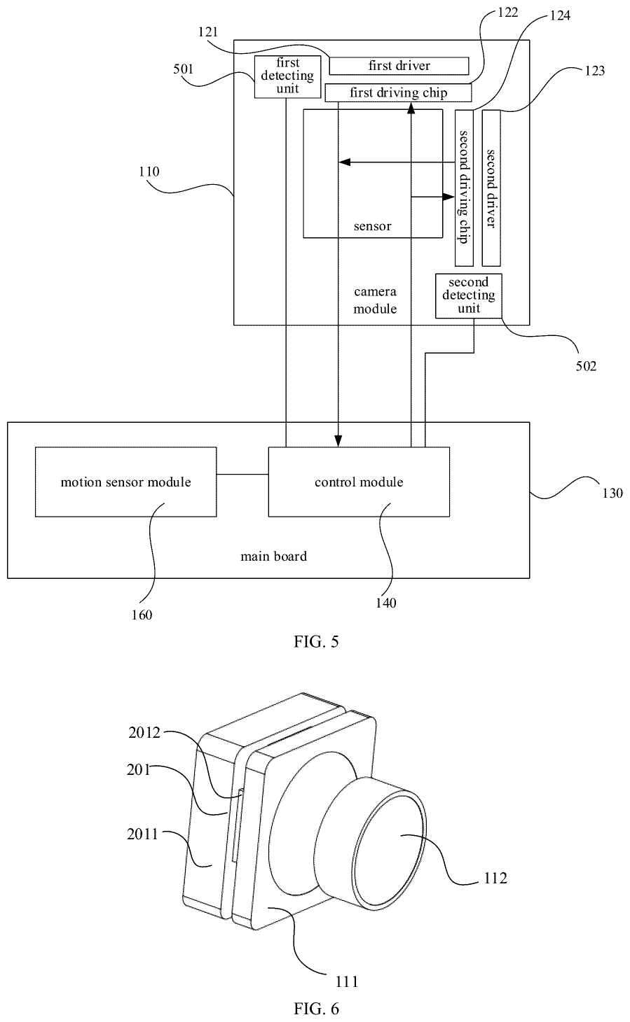

As shown in FIG. 5, the anti-shake motor assembly 120 may include a first driver 121 and a second driver 123. The first driver 121 is connected to the camera module 110 and is configured to drive the camera module 110 to rotate around the first direction. The second driver 123 is connected to the camera module 110 and is configured to drive the camera module 110 to rotate around the second direction. The first direction is perpendicular to the second direction.

The first driver 121 and the second driver 123 may be voice coil motors or shape memory alloy (SMA) motors. The first driver 121 and the second driver 123 may be separate motors. Alternatively, the first driver 121 and the second driver 123 may be one same motor, in which the first driver 121 is a driving portion of the same motor in the first direction, and the second driver 123 is a driving portion of the same motor in the second direction.

In some embodiments, the anti-shake motor assembly 120 may also include a first driving chip 122 and a second driving chip 124. The first driving chip 122 includes a first driving circuit, and the first driving circuit is electrically coupled to the control module 140 and the first driver 121. The first driving circuit is configured to transmit the driving electrical signal to the first driver 121. The second driving chip 124 includes a second driving circuit, and the second driving circuit is electrically coupled to the control module 140 and the second driver 123. The second driving circuit is configured to transmit the driving electrical signal to the second driver 123. That is, the first driving chip 122 is electrically coupled to the control module 140 and the first driver 121, and the second driving chip 124 is electrically coupled to the control module 140 and the second driver 123.

The first driving chip 122 and the second driving chip 124 may be two independent driving-chips. In practical applications, the first driving chip 122 and the second driving chip 124 may also be a same driving-chip, and the first driving circuit and the second driving circuit are provided on the same driving chip, which are not limited in the embodiments of the present disclosure.

In the embodiments of the present disclosure, the control module 140 is arranged on the main board 130 of the electronic device 1, the anti-shake motor assembly 120 is arranged on the camera module 110, and the anti-shake motor assembly 120 is electrically coupled to the control module 140. The anti-shake motor assembly 120 may be connected to the control module 140 through an inter-integrated circuit (I2C) bus. The I2C bus may be disposed on a flexible circuit board, and the flexible circuit board extends from the main board 130 to the camera module 110. For example, the control module 140 may be connected to the first driving circuit and the second driving circuit through the I2C bus.

In some embodiments of the present disclosure, as shown in FIG. 6, the anti-shake motor assembly 120 may be arranged on the sensor 111. The anti-shake motor assembly 120 may include a first motor 201. The first motor 201 is connected to the sensor 111, and the first motor 201 is configured to drive the sensor 111 to achieve optical anti-shake of the sensor 111. The first motor 201 may drive the sensor 111 to rotate. For example, the first motor 201 may drive the sensor 111 to move based on the motion of the electronic device 1.

In some embodiments, the first motor 201 may drive the sensor 111 to rotate around an X-axis and a Y-axis. A light incident direction of the sensor 111 may be a direction along a Z-axis. The X-axis is perpendicular to the Y-axis, and both the X-axis and the Y-axis are perpendicular to the Z-axis.

The first motor 201 may be an SMA motor. The first motor 201 includes a first motor body 2011 and a first driving unit 2012. The first driving unit 2012 is connected to the first motor body 2011. The first driving unit 2012 is connected to a rear surface of the sensor 111. The first motor body 2011 may include a base, the base is connected to the first driving unit 2012, and the base may be fixed on the electronic device 1 during use. The first driving unit 2012 may include a plurality of SMA wires. The SMA wires are connected to the base. The SMA wires may shrink after being power-on, thereby driving the sensor 111 to rotate.

In some embodiments, the first driving unit 2012 may include four SMA wires. The sensor 111 includes a rectangular parallelepiped structure, and a corresponding one of the four SMA wires is arranged at each side of the sensor 111. When performing optical anti-shake, the electrical signal may be provided to a corresponding SMA wire based on the shaking of the electronic device 1 to drive the sensor 111 to rotate.

The four SMA wires include a first SMA wire, a second SMA wire, a third SMA wire, and a fourth SMA wire. The first SMA wire, the second SMA wire, the third SMA wire, and the fourth SMA wire are sequentially arranged at four sides of the sensor 111. The first SMA wire and the third SMA wire are configured to drive the sensor 111 to rotate around the X-axis, and the second SMA wire and the fourth SMA wire are configured to drive the sensor 111 to rotate around the Y-axis.

In practical applications, the first motor 201 may also be a voice coil motor (VCM) or other motor that operates in electromagnetic effects, and the embodiments of the present disclosure is not limited thereto.

The first motor 201 is connected to the sensor 111, and the first motor 201 is configured to drive the sensor 111 to achieve optical anti-shake of the sensor 111. The first motor 201 may drive the sensor 111 to rotate. For example, the first motor 201 may drive the sensor 111 to move based on the motion of the electronic device.

In some embodiments, the first motor 201 may drive the sensor 111 to rotate around the X-axis and the Y-axis. The light incident direction of the sensor 111 may be the direction along the Z-axis. The X-axis is perpendicular to the Y-axis, and both the X-axis and the Y-axis are perpendicular to the Z-axis.

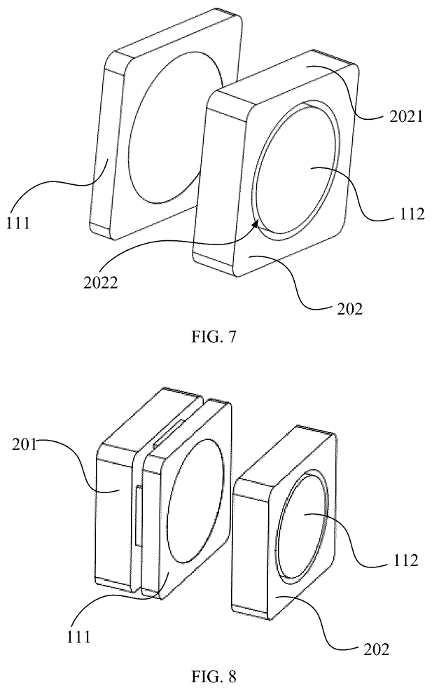

In some embodiments of the present disclosure, as shown in FIG. 7, the anti-shake motor assembly 120 may be arranged on the lens 112. The anti-shake motor assembly 120 may include a second motor 202. The second motor 202 is connected to the lens 112, and the second motor 202 is configured for driving the lens 112 to rotate to achieve optical anti-shake of the lens 112.

In some embodiments, the second motor 202 may be an SMA motor. The second motor 202 includes a second motor body 2021 and a second driving unit 2022. The second driving unit 2022 is connected to the second motor body 2021. The second driving unit 2022 is connected to the lens 112. The second motor body 2021 may include a base, the base is connected to the second driving unit 2022, and the base may be fixed on the electronic device 1 during use. The second driving unit 2022 may include a plurality of SMA wires. The SMA wires are connected to the base. The SMA wires may shrink after being power-on, thereby driving the lens 112 to rotate.

The second motor body 2021 may be defined with a through hole, and the lens 112 is disposed in the through hole. The second driving unit 2022 is connected to the second motor body 2021 and the lens 112. The second driving unit 2022 may include a plurality of SMA wires. The plurality of SMA wires are arranged in the through hole along a circumference of the through hole on the motor body, and connected to an outer wall of the lens 112. When performing optical anti-shake, the electrical signal may be provided to a corresponding SMA wire based on the shaking of the electronic device 1 to drive the lens 112 to rotate.

The second driving unit 2022 may include four SMA wires. The four SMA wires include a first SMA wire, a second SMA wire, a third SMA wire, and a fourth SMA wire. The first SMA wire, the second SMA wire, the third SMA wire, and the fourth SMA wire are sequentially arranged in the through hole of the second motor body 2021. The first SMA wire and the third SMA wire are configured to drive the lens 112 to rotate around the X-axis, and the second SMA wire and the fourth SMA wire are configured to drive the lens 112 to rotate around the Y-axis.

In practical applications, the second motor 202 may also be a VCM or other motor that operates by electromagnetic effects, and the embodiment of the present disclosure is not limited thereto. For example, the second motor 202 may be a ball motor in which magnets, coils, and balls are used for rotation.

In some embodiments of the present disclosure, as shown in FIG. 8, the anti-shake motor assembly 120 may be connected to both the sensor 111 and the lens 112. The anti-shake motor assembly 120 may include the first motor 201 and the second motor 202. The first motor 201 is connected to the sensor 111, and the second motor 202 is connected to the lens 112. The control module 140 is electrically coupled to the first motor 201 and the second motor 202. The control module 140 is configured for controlling the first motor 201 to drive the sensor 111 and controlling the second motor 202 to drive the lens 112, thereby achieving optical anti-shake of imaging assemblies.

The first motor 201 is connected to the sensor 111, and the first motor 201 is configured to drive the sensor 111, thereby achieving optical anti-shake of the sensor 111. The first motor 201 may drive the sensor 111 to rotate. For example, the first motor 201 may drive the sensor 111 to move based on the motion of the electronic device 1.

In some embodiments, the first motor 201 may drive the sensor 111 to rotate around the X-axis and the Y-axis. The light incident direction of the sensor 111 may be the direction along the Z-axis. The X-axis is perpendicular to the Y-axis, and both the X-axis and the Y-axis are perpendicular to the Z-axis.

The first motor 201 may be an SMA motor. The first motor 201 includes the first motor body 2011 and the first driving unit 2012. The first driving unit 2012 is connected to the first motor body 2011. The first driving unit 2012 is connected to the rear surface of the sensor 111. The first motor body 2011 may include a base connected to the first driving unit 2012, and the base may be fixed on the electronic device 1 during use. The first driving unit 2012 may include a plurality of SMA wires. The SMA wires are connected to the base. The SMA wires may shrink after being power-on, thereby driving the sensor 111 to rotate.

In some embodiments, the first driving unit 2012 may include four SMA wires. The sensor 111 includes a rectangular parallelepiped structure, and a corresponding one of the four SMA wires is arranged at each side of the sensor 111. When performing optical anti-shake, the electrical signal may be provided to a corresponding SMA wire based on the shaking of the electronic device 1 to drive the sensor 111 to rotate.

The four SMA wires include a first SMA wire, a second SMA wire, a third SMA wire, and a fourth SMA wire. The first SMA wire, the second SMA wire, the third SMA wire, and the fourth SMA wire are sequentially arranged at four sides of the sensor 111. The first SMA wire and the third SMA wire are configured to drive the sensor 111 to rotate around the X-axis, and the second SMA wire and the fourth SMA wire are configured to drive the sensor 111 to rotate around the Y-axis.

In practical applications, the first motor 201 may also be a VCM or other motor that operates by electromagnetic effects, and the embodiments of the present disclosure is not limited thereto.

The first motor 201 is connected to the sensor 111, and the first motor 201 is configured to drive the sensor 111 to achieve optical anti-shake of the sensor 111. The first motor 201 may drive the sensor 111 to rotate. For example, the first motor 201 may drive the sensor 111 to move based on the motion of the electronic device 1.

In some embodiments, the first motor 201 may drive the sensor 111 to rotate around the X-axis and the Y-axis. The light incident direction of the sensor 111 may be the direction along the Z-axis. The X-axis is perpendicular to the Y-axis, and both the X-axis and the Y-axis are perpendicular to the Z-axis.

The second motor 202 may be an SMA motor. The second motor 202 includes the second motor body 2021 and the second driving unit 2022. The second driving unit 2022 is connected to the second motor body 2021. The second driving unit 2022 is connected to the lens 112. The second motor body 2021 may include a base, the base is connected to the second driving unit 2022, and the base may be fixed on the electronic device 1 during use. The second driving unit 2022 may include a plurality of SMA wires. The SMA wires are connected to the base. The SMA wires may shrink after being power-on, thereby driving the lens 112 to rotate.

In some embodiments, the second motor body 2021 may be defined with a through hole, and the lens 112 is disposed in the through hole. The second driving unit 2022 is connected to the second motor body 2021 and the lens 112. The second driving unit 2022 may include a plurality of SMA wires. The plurality of SMA wires are arranged in the through hole along a circumference of the through hole on the motor body, and connected to an outer wall of the lens 112. When performing optical anti-shake, an electrical signal may be provided to a corresponding SMA wire based on the shaking of the electronic device 1 to drive the lens 112 to rotate.

The second driving unit 2022 may include four SMA wires. The four SMA wires include a first SMA wire, a second SMA wire, a third SMA wire, and a fourth SMA wire. The first SMA wire, the second SMA wire, the third SMA wire, and the fourth SMA wire are sequentially arranged in the through hole of the second motor body 2021. The first SMA wire and the third SMA wire are configured to drive the lens 112 to rotate around the X-axis, and the second SMA wire and the fourth SMA wire are configured to drive the lens 112 to rotate around the Y-axis.

In practical applications, the second motor 202 may also be a VCM or other motor that operates by electromagnetic effects, and the embodiment of the present disclosure is not limited thereto. For example, the second motor 202 may be a ball motor in which magnets, coils, and balls are used for rotation.

The control module 140 is connected to the first motor 201 and the second motor 202. The control module 140 is configured for controlling the first motor 201 to drive the sensor 111 and controlling the second motor 202 to drive the lens 112, thereby achieving optical anti-shake of the imaging assemblies.

The control module 140 is configured to determine a first rotation angle and a second rotation angle based on a rated stroke of the first motor 201, a rated stroke of the second motor 202, and an anti-shake angle. The control module 140 is configured to control the first motor 201 to drive the sensor 111 to rotate by the first rotation angle, and control the second motor 202 to drive the lens 112 to rotate by the second rotation angle. The anti-shake angle is a total rotation angle of the camera module 110 required for optical anti-shake determined by the control module 140 based on the motion sensor module 160 of the electronic device 1.

In some embodiments, the control module 140 may determine the first rotation angle and the second rotation angle based on a ratio of the rated stroke of the first motor 201 to the rated stroke of the second motor 202. That is, the ratio of the rated stroke of the first motor 201 to the rated stroke of the second motor 202 is the same as a ratio of the first rotation angle to the second rotation angle. For example, if the rated stroke of the first motor 201 is 400 microns and the rated stroke of the second motor 202 is 200 microns. A ratio of the first rotation angle to the second rotation angle is 400:200=2:1. When the electronic device 1 shakes by 3 degrees, the first motor 201 drives the sensor 111 to rotate by 2 degrees, and the second motor 202 drives the lens 112 to rotate by 1 degree.

Alternatively, the control module 140 may prioritize the anti-shake angle to the first motor 201 based on the rated stroke of the first motor 201 and the rated stroke of the second motor 202. When the anti-shake angle is less than or equal to the rated stroke of the first motor 201, the first motor 201 drives the sensor 111 for anti-shake. When the anti-shake angle is greater than the rated stroke of the first motor 201, an extra anti-shake angle is allocated to the second motor 202, and the first motor 201 drives the sensor 111 and the second motor 202 drives the lens 112 to achieve optical anti-shake.

Alternatively, the control module 140 may prioritize the anti-shake angle to the second motor 202 based on the rated stroke of the first motor 201 and the rated stroke of the second motor 202. When the anti-shake angle is less than or equal to the rated stroke of the second motor 202, the second motor 202 drives the lens 112 for anti-shake. When the anti-shake angle is greater than the rated stroke of the second motor 202, an extra anti-shake angle is allocated to the first motor 201, and the first motor 201 drives the sensor 111 and the second motor 202 drives the lens 112 to achieve optical anti-shake.

In the embodiments of the present disclosure, in order to improve the accuracy of optical anti-shake, the anti-shake accuracy may be compensated by linkage control of the first motor 201 and the second motor 202. In some embodiments, the control module 140 may correct the second rotation angle based on a first actual angle detected by the detecting module 150 and the first rotation angle, and drive the second motor 202 to rotate by the corrected second rotation angle. The first actual angle is an actual angle rotating by the sensor 111.

The second rotation angle may be corrected and compensated by the first actual angle through the following ways.

$$HSST 2 = HSST 1 + k \times ( HLS 1 - HLST 1 ) .$$

HSST2 is the corrected second rotation angle, HSST1 is an initial second rotation angle, HLS1 is the first actual angle, HLST1 is an initial first rotation angle, and k is a compensation coefficient. The initial first rotation angle is the first rotation angle determined by the control module 140, and the initial second rotation angle is the second rotation angle determined by the control module 140. During driving, the lens 112 moves by the corrected second rotation angle. The value of k is calibrated based on a best anti-shake effect and used as a linkage compensation coefficient. That is, the value of k may be obtained by test calibration, stored in the electronic device 1, and called during compensation.

It should be noted that in the embodiments of the present disclosure, the first motor 201 and the second motor 202 may work simultaneously. When starting to work, the control module 140 controls the first motor 201 based on the first rotation angle, and the control module 140 controls the second motor 202 based on the second rotation angle. After the first motor 201 finishes driving the sensor 111, the first actual angle by which the sensor 111 rotates is obtained, the corrected second rotation angle is determined based on the first actual angle, and then the second motor 202 is controlled to adjust the rotation angle of the lens 112 based on the corrected second rotation angle.

It can be understood that in some embodiments of the present disclosure, the first motor 201 may work first, and when the first motor 201 finishes driving the sensor 111, the second motor 202 may work. Before the second motor 202 works, the corrected second rotation angle may be determined based on the first actual angle and the initial second rotation angle. The second motor 202 drives the lens 112 based on the corrected second rotation angle.

In some embodiments, the control module 140 corrects the first rotation angle based on a second actual angle detected by the detecting module 150 and the second rotation angle, and drives the first motor 201 to rotate by the corrected first rotation angle. The second actual angle is an actual angle rotating by the lens 112.

The first rotation angle may be corrected and compensated by the second actual angle through the following ways.

$$HSST 1 = HSST 2 + k \times ( HLS 2 - HLST 2 ) .$$

HSST1 is the corrected first rotation angle, HSST2 is an initial first rotation angle, HLS2 is the second actual angle, HLST2 is an initial second rotation angle, and k is a compensation coefficient. The initial second rotation angle is the second rotation angle determined by the control module 140, and the initial first rotation angle is the first rotation angle determined by the control module 140. During driving, the sensor 111 moves by the corrected first rotation angle. The value of k is calibrated based on a best anti-shake effect and used as a linkage compensation coefficient. That is, the value of k may be obtained by test calibration, stored in the electronic device 1, and called during compensation.

It should be noted that in the embodiments of the present disclosure, the first motor 201 and the second motor 202 may work simultaneously. When starting to work, the control module 140 controls the first motor 201 based on the first rotation angle, and the control module 140 controls the second motor 202 based on the second rotation angle. After the second motor 202 finishes driving the lens 112, the second actual angle by which the lens 112 rotates is obtained, the corrected first rotation angle is determined based on the second actual angle, and then the first motor 201 is controlled to adjust the rotation angle of the sensor 111 based on the corrected first rotation angle.

It can be understood that in some embodiments of the present disclosure, the second motor 202 may work first. When the second motor 202 finishes driving the lens 112, the first motor 201 may work. Before the first motor 201 works, the corrected first rotation angle may be determined based on the second actual angle and the initial first rotation angle. The first motor 201 drives the sensor 111 by the corrected first rotation angle.

The detecting module 150 may include a Hall sensor 151 and an amplification circuit 152. The Hall sensor 151 is arranged on the camera module 110 and configured to collect the position of the camera module 110. The amplification circuit 152 is electrically coupled to the Hall sensor 151 and the control module 140. The amplification circuit is configured to amplify a signal collected by the Hall sensor 151 and transmit the amplified signal to the control module 140.

When the anti-shake motor assembly 120 includes the first driver 121 and the second driver 123, the detecting module 150 may include a first detecting unit 501 and a second detecting unit 502. The first detecting unit 501 is arranged on the camera module 110, and the first detecting unit 501 is configured to detect an actual angle of the camera module 110 rotating around the first direction. The second detecting unit 502 is arranged on the camera module 110, and the second detecting unit 502 is configured to detect an actual angle of the camera module 110 rotating around the second direction.

The first detecting unit 501 may include a first Hall sensor and a first amplification circuit. The first Hall sensor is arranged on the camera module 110 and is configured to collect position information of the camera module 110 in the first direction. The first amplification circuit is connected to the first Hall sensor and the control module 140. The first amplification circuit is configured to amplify a signal collected by the first Hall sensor and transmit the amplified signal to the control module 140.

The second detecting unit 502 may include a second Hall sensor and a second amplification circuit. The second Hall sensor is arranged on the camera module 110 and is configured to collect position information of the camera module 110 in the second direction. The second amplification circuit is connected to the second Hall sensor and the control module 140. The second amplification circuit is configured to amplify a signal collected by the second Hall sensor and transmit the amplified signal to the control module 140.

When the first motor 201 is arranged on the sensor 111 and the second motor 202 is arranged on the lens 112, a set of sensing modules may be provided respectively on the sensor 111 and the lens 112. For example, the first detecting unit 501 and the second detecting unit 502 are arranged on the sensor 111 to respectively detect the positions of the sensor 111 in the first direction and the second direction. The first detecting unit 501 and the second detecting unit 502 are arranged on the lens 112 to respectively detect the positions of the lens 112 in the first direction and the second direction.

The amplification circuit 152 may include an amplifier 1521, an analog-to-digital conversion unit (ADC) 1522, and a digital-to-analog conversion unit (DAC) 1523. An input terminal of the amplifier 1521 is electrically coupled to the Hall sensor 151. The analog-to-digital conversion unit 1522 is electrically coupled to an output terminal of the amplifier 1521 and connected to the servo control unit 142. The digital-to-analog conversion unit 1523 may be electrically coupled to a control terminal of the amplifier 1521.

In the embodiments of the present disclosure, when controlling the first driver 121 and the second driver 123, the control module 140 may obtain the positions of the first driver 121 and the second driver 123 through the detecting module 150. Therefore, during closed-loop control, the linkage control of the first driver 121 and the second driver 123 may be realized, avoiding the problem of poor control accuracy due to factors such as magnetic interference when the first driver 121 or the second driver 123 is driven alone.

In some embodiments, the control module 140 obtains the actual angle of the camera module 110 around the first direction from the first detecting unit 501, and compensate the rotation angle of the camera module 110 around the second direction determined by the control module 140 based on the actual angle of the camera module 110 around the first direction.

Alternatively, the control module 140 obtains the actual angle of the camera module 110 around the second direction from the second detecting unit 502, and compensate the rotation angle of the camera module 110 around the first direction determined by the control module 140 based on the actual angle of the camera module 110 around the second direction.

The electronic device 1 provided by the embodiments of the present disclosure realizes the control of the anti-shake motor assembly 120 by arranging the anti-shake motor assembly 120 on the camera module 110 to drive the camera module 110 and arranging the control module 140 on the main board 130 to output the driving electrical signal, thereby realizing optical anti-shake of the electronic device 1. In addition, the control module 140 is arranged on the main board 130, avoiding the problem of low optical anti-shake control accuracy caused by the integration of the control module 140 into the camera module 110, allowing the electronic device 1 to control the optical anti-shake in a targeted manner based on the status of the electronic device 1, which is conducive to improve the accuracy of optical anti-shake of the electronic device 1. Furthermore, the control module 140 is arranged separately from the camera module 110, which may reduce the cost of the camera module 110 and save the cost of the electronic device 1, and may also avoid the problem of reduced anti-shake accuracy caused by resonance or magnetic interference, thereby further improving the accuracy of optical anti-shake of the electronic device 1.

Other embodiments of the present disclosure may be readily apparent to those skilled in the art from consideration of the specification and practice of the invention disclosed herein. The present disclosure is intended to cover any variations, uses, or adaptations of the present disclosure that follow general principles of the present disclosure and include common knowledge or customary technical means in the technical field that are not disclosed in the present disclosure. The specification and embodiments are considered illustrative only, and a true scope and spirit of the present disclosure are indicated by the attached claims.

What is claimed is:

1. An electronic device, comprising:
a camera module;
an anti-shake motor assembly, arranged on the camera module;
a main board; and
a control module, arranged on the main board and electrically coupled to the anti-shake motor assembly, the control module being configured to determine a driving electrical signal based on a motion state of the electronic device and transmit the driving electrical signal to the anti-shake motor assembly, and the driving electrical signal being configured to drive the anti-shake motor assembly to achieve optical anti-shake.

2. The electronic device according to claim 1, further comprising:
a detecting module, arranged on the camera module and configured to detect a position of the camera module, wherein the detecting module is electrically coupled to the control module to feedback the position of the camera module to the control module.

3. The electronic device according to claim 2, wherein the detecting module comprises:
a Hall sensor, arranged on the camera module and configured to collect the position of the camera module; and
an amplification circuit, electrically coupled to the Hall sensor and the control module, and configured to amplify and transmit a signal collected by the Hall sensor to the control module.

4. The electronic device according to claim 2, wherein the control module comprises:
an anti-shake determining unit, configured to determine a target angular displacement of an anti-shake motor of the anti-shake motor assembly based on the motion state of the electronic device; and
a servo control unit, electrically coupled to the anti-shake determining unit, the detecting module, and the anti-shake motor assembly, and configured to control the anti-shake motor based on the target angular displacement and the position of camera module.

5. The electronic device according to claim 4, wherein the amplification circuit comprises:
an amplifier, comprising an input terminal, an output terminal, and a control terminal, the input terminal being electrically coupled to the Hall sensor;
an analog-to-digital conversion unit, electrically coupled to the output terminal and the servo control unit; and
a digital-to-analog conversion unit, electrically coupled to the control terminal.

6. The electronic device according to claim 2, wherein the anti-shake motor assembly comprises:
a first driver, connected to the camera module and configured to drive the camera module to rotate around a first direction; and
a second driver, connected to the camera module and configured to drive the camera module to rotate around a second direction, wherein the first direction is perpendicular to the second direction.

7. The electronic device according to claim 6, wherein the anti-shake motor assembly further comprises:
a first driving chip is electrically coupled to the control module and the first driver, and configured to transmit the driving electrical signal to the first driver; and
a second driving chip electrically coupled to the control module and the second driver, and configured to transmit the driving electrical signal to the second driver.

8. The electronic device according to claim 6, wherein the detecting module comprises:
a first detecting unit, arranged on the camera module and configured to detect an actual angle of the camera module around the first direction; and
a second detecting unit, arranged on the camera module and configured to detect an actual angle of the camera module around the second direction.

9. The electronic device according to claim 8, wherein the control module is electrically coupled to the first detecting unit and the second detecting unit;
the control module is configured to obtain the actual angle of the camera module around the first direction from the first detecting unit, and compensate a rotation angle of the camera module around the second direction determined by the control module based on the actual angle of the camera module around the first direction; or
the control module is configured to obtain the actual angle of the camera module around the second direction from the second detecting unit, and compensate a rotation angle of the camera module around the first direction determined by the control module based on the actual angle of the camera module around the second direction.

10. The electronic device according to claim 1, wherein the camera module comprises:
a lens, configured to collect ambient lights; and
a sensor, configured to receive the lights transmitted by the lens and convert an optical signal into an electrical signal.

11. The electronic device according to claim 10, wherein the anti-shake motor assembly comprises:
a first motor, arranged on the sensor and configured to drive the sensor to achieve optical anti-shake of the sensor.

12. The electronic device according to claim 11, wherein the first motor is a shape memory alloy motor, and the first motor comprises:
a first motor body; and
a first driving unit, connected to the first motor body and a rear surface of the sensor.

13. The electronic device according to claim 10, wherein the anti-shake motor assembly comprises:
a second motor, arranged on the lens and configured to drive the lens to achieve optical anti-shake of the lens.

14. The electronic device according to claim 13, wherein the second motor comprises:
a second motor body; and
a second driving unit, connected to the second motor body and the lens.

15. The electronic device according to claim 14, wherein a through hole is defined on the second motor body, and the lens is disposed in the through hole.

16. The electronic device according to claim 1, further comprising:
a motion sensor module, electrically coupled to the control module and configured to detect the motion state of the electronic device and transmit the motion state of the electronic device to the control module.

17. The electronic device according to claim 16, wherein the motion sensor module comprises a gyroscope sensor or a six-axis acceleration sensor.

18. An electronic device, comprising:
a camera module;
an anti-shake motor assembly, arranged on the camera module; and
a control module, electrically coupled to the anti-shake motor assembly and non-integrated into the camera module, the control module being configured to determine a driving electrical signal based on a motion state of the electronic device and transmit the driving electrical signal to the anti-shake motor assembly, and the driving electrical signal being configured to drive the anti-shake motor assembly to achieve optical anti-shake.

19. The electronic device according to claim 18, further comprising:
a circuit board, independent from the camera module;
wherein the control module is arranged on the circuit board.

20. An electronic device, comprising:
a camera module;
an anti-shake motor assembly, arranged on the camera module;
a circuit board, independent from the camera module; and
a control module, arranged on the circuit board and electrically coupled to the anti-shake motor assembly, the control module being configured to determine a driving electrical signal based on a motion state of the electronic device and transmit the driving electrical signal to the anti-shake motor assembly, and the driving electrical signal being configured to drive the anti-shake motor assembly to achieve optical anti-shake.
